(19) United States
(12) Patent Application Publication
(10) Pub. No.: US 2024/0089254 A1
(43) Pub. Date: Mar. 14, 2024

(54) PROXIMITY-AWARE MULTIFACTOR AUTHENTICATION FOR CONTINUOUS TRUSTED ACCESS

(71) Applicant: Cisco Technology, Inc., San Jose, CA (US)

(72) Inventors: Vincent E. Parla, North Hampton, NH (US); Nancy Patricia Cam-Winget, Mountain View, CA (US)

(21) Appl. No.: 17/940,299

(22) Filed: Sep. 8, 2022

(51) Int. Cl. H04L 9/40

(52) U.S. Cl. CPC H04L 63/0853; H04L 63/20

(57) ABSTRACT

Techniques for using device proximity of a primary device and a secondary device to allow or deny connections to network resource(s), as well as terminate existing connections to the network resource(s). The techniques may include monitoring a proximity-based direct networking connection between a primary device and a secondary device, the proximity-based direct networking connection established in association with authenticating the primary device to access a resource. The techniques may also include determining, based at least in part on the monitoring, that a network proximity between the primary device and the secondary device exceeds a threshold proximity. Based at least in part on determining that the network proximity exceeds the threshold proximity, the techniques may include causing termination of the access to the resource for the primary device.

### TECHNICAL FIELD

The present disclosure relates generally to techniques for, among other things, using device proximity of a primary device and a secondary device to allow, deny or terminate connections to network resource(s)

### BACKGROUND

When multifactor authentication (MFA) techniques are used to authenticate a workflow on a first device, a push notification is generally sent to a second device to authenticate the workflow. However, there are issues that exist with these basic MFA techniques. For example, the first device can be in a different physical location than the second device, and this can be true even when the two devices are in the same internet protocol (IP), Wi-Fi, or Cellular geolocation. Moreover, the two devices might actually be in proximity, but are using entirely different networks or network technologies, such as wired, Wi-Fi, or cellular. Additionally, once a workflow has been authenticated based on a successful MFA authentication, there is no way to continuously monitor the authenticated workflow and terminate the session if a change in proximity or other policy violation occurs.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIGS. 1A and 1B collectively illustrate an example architecture that may implement various aspects of the technologies described herein, a portion of which being illustrated by the example steps “1-13” shown in FIGS. 1A and 1B.

FIG. 2 illustrates an example implementation of the techniques described herein in which a data channel is used to provide a second level of assurance in a multifactor authentication workflow.

FIG. 3 is a flow diagram illustrating an example method associated with the techniques described herein for proximity-aware multifactor authentication for continuous trusted access.

FIG. 4 is a computer architecture diagram showing an illustrative computer hardware architecture for implementing a computing device that can be utilized to implement aspects of the various technologies presented herein.

### DESCRIPTION OF EXAMPLE EMBODIMENTS

### Overview

This disclosure describes various technologies for utilizing device proximity of a primary device and a secondary device to allow or deny connections to secured resource(s), as well as terminate existing connections to the secured resource(s). By way of example, and not limitation, the techniques described herein may include monitoring a proximity-based direct networking connection between a primary device and a secondary device, the proximity-based direct networking connection established in association with authenticating the primary device to access a resource. The techniques may also include determining, based at least in part on the monitoring, that a network proximity between the primary device and the secondary device exceeds a threshold proximity. Based at least in part on determining that the network proximity exceeds the threshold proximity, the techniques may include causing termination of the access to the resource for the primary device.

Additionally, the techniques described herein may be performed as a method and/or by a system having non-transitory computer-readable media storing computer-executable instructions that, when executed by one or more processors, performs the techniques described above and herein.

### Example Embodiments

As noted above, several issues exist with today's basic multifactor authentication (MFA) techniques. For example, a first device can be in a different physical location than a second device, and this can be true even when the two devices are in the same internet protocol (IP), Wi-Fi, or Cellular geolocation. Moreover, the two devices might actually be in proximity, but are using entirely different networks or network technologies, such as wired, Wi-Fi, or cellular. Additionally, once a workflow has been authenticated based on a successful MFA authentication, there is no way to continuously monitor the authenticated workflow and terminate the session if a security policy violation occurs, such as when the authenticated user of the first device is away from the first device (e.g., not within a proximity of the first device).

As an example, a user may start a session with Office365 on their computer (e.g., laptop, desktop, etc.) and authenticate the session by responding positively to an MFA notification pushed to their cell phone. However, at some point after the session has been authenticated and while the session is still active, the user may leave the room or even the premises where their computer is located, thereby leaving their computer unattended with an active Office365 session running and vulnerable to access by unauthorized users.

This disclosure is directed to techniques that, among other things, utilize the proximity of a primary device (e.g., authenticated device, the computer in the above example) to a secondary device (e.g., authenticating device, the cell phone in the above example) to allow or deny connections to secured resource(s), as well as terminate existing connections to the secured resource(s) (e.g., application(s), service(s), etc.). In some examples, the technologies described in this disclosure may include establishing a proximity-based direct networking connection (e.g., near-field communication (NFC) connection, Bluetooth connection, or another direct, peer to peer connection) between the primary device and the secondary device to be used as an authentication factor in an MFA workflow to determine whether the secondary device, and hence the user, is within a threshold proximity of the primary device. Additionally, this proximity-based direct networking connection may be continuously monitored throughout the life of the authenticated session such that when the secondary device moves away from the primary device and the proximity-based direct networking connection fails or becomes weak, a signal may be sent (e.g., to a Continuous Access Evaluation Protocol (CAEP) ecosystem) to cause the existing session to be terminated based on policy. In some instances, this proximity change could additionally, or alternatively, be determined based on associations with new/different SSID(s) or Network IP addresses.

Turning back to the above-described example, in response to the user leaving the room or the premises where their computer is located, the technologies described in this disclosure would cause the user's Office365 session to be terminated, at least assuming that the user has taken their cell phone with them upon leaving their computer unattended. For instance, during authentication, a proximity-based direct networking connection may be established between the user's computer and the user's cell phone to authenticate that the user is in proximity of the computer. Upon the user leaving the room or the premises where the computer is located, and assuming that the user took their cell phone with them, the proximity-based direct networking connection would fail as the cell phone moved out of range of the computer. In response to this, a signal may be sent (e.g., by an MFA application running on the user's computer and/or the user's cell phone) to cause the Office365 session to be terminated.

In some examples, the techniques of this disclosure may be used in cases where the primary device is both the authenticated device and the authenticating device for the secured session (e.g., Web Authentication (WebAuthn)). For instance, a secondary device association via NFC, Bluetooth, or the like may be used as a stronger binding mechanism. Since it is common for users to carry their cell phone device with them wherever they go, the cell phone can be used a proximity sensor to their computer to ensure the user has not left their computer unattended with an active session. While keyboard activity or screensaver activity could additionally, or alternatively, be monitored and used for this, it may be less reliable than the proximity sensor approach described herein. For instance, in a case of a primary device being left inadvertently at a coffee shop, for instance, the proximity sensor approach techniques described herein may be the only protection against an attacker who may have access to the lost primary device shortly after it was misplaced (e.g., by exercising the keyboard).

As used herein, the term “primary device” means the authenticated device that is attempting to establish an authenticated/secured session. Additionally, the term “secondary device” means the authenticating device that may receive an MFA push notification to authenticate the session for the primary device. In many cases, a primary device would be a user's laptop or desktop computer, and a secondary device would be the user's cell phone or other mobile device (e.g., tablet). However, it is to be understood that other combinations of primary and secondary devices exist, as those having ordinary skill in the art will understand. For instance, a cell phone or tablet may be a primary device and a laptop or desktop computer may be a secondary device in an MFA workflow, in some examples. As another example, a tablet may be a primary device and a cell phone may be a secondary device, in some instances.

By way of example, and not limitation, a method according to the technologies described herein may include determining to establish a proximity-based direct networking connection between a primary device and a secondary device of a user in association with authenticating the primary device to access a resource (e.g., application, service, tunnel headend, etc.). In some examples, a multifactor authentication (MFA) application running on the secondary device may determine to establish the proximity-based direct networking connection between the primary device and the secondary device in response to receiving an MFA push notification. For instance, the secondary device may receive the MFA push notification in response to the user of the primary device attempting to authenticate to access a secured resource using the primary device, and the MFA push notification may indicate that the proximity-based direct networking connection needs to be established as a factor for an MFA workflow associated with authenticating the primary device.

In some examples, the method may include establishing the proximity-based direct networking connection between the primary deice and the secondary device. In some examples, the MFA application running on the secondary device may cause the proximity-based direct networking connection to be established between the primary device and the secondary device. For instance, the MFA application may cause the secondary device to establish a Bluetooth, NFC, Wi-Fi, or other proximity-based networking connection (including both direct connections and indirect connections through a router) with the primary device. In some examples, if an active proximity-based direct networking connection already exists between the primary device and the secondary device, the MFA application may determine that such a connection already is active and refrain from causing a new proximity-based direct networking connection to be established. In some example, other techniques may be used besides proximity-based direct networking connections to show proximity. For instance, if the secondary device is plugged into the primary device, the MFA application may determine that this condition suffices as an exception to establishing a new proximity-based direct networking connection.

In some examples, upon establishing the proximity-based direct networking connection—or determining that an existing connection is active or that a sufficient, alternative connection exists—an indication may be sent to an authentication service (e.g., MFA service) to indicate that the proximity-based direct networking connection has been established. In some examples, an active proximity-based direct networking connection between the primary device and the secondary device may be a factor of the MFA workflow, and upon the authentication service receiving the indication of the active proximity-based direct networking connection, the authentication service may grant the primary device with access to the resource. That is, the authentication service may authenticate the primary device to establish a communication session with the resource, or to otherwise access the resource.

In some examples, while the session is active for the primary device to access the resource, it may be required (e.g., by a security policy associated with either one of the resource or an organization of the user) that the proximity-based direct networking connection remain active. As such, the techniques may include monitoring the proximity-based direct networking connection between the primary device and the secondary device. In some examples, the proximity-based direct networking connection may be monitored by the MFA application running on the secondary device, by another MFA application running on the primary device, by a monitoring service (e.g., a Continuous Access Evaluation Protocol (CAEP) system), and/or the like. For instance, the MFA application running on the secondary device may monitor the health of the proximity-based direct networking connection (e.g., whether the connection is active, whether the connection is stable, the strength of the connection, etc.) by receiving and/or analyzing data associated with the proximity-based direct networking connection. Additionally, or alternatively, the monitoring service may monitor the proximity-based direct networking connection by, for instance, receiving telemetry data associated with the proximity-based direct networking connection from the primary device and/or the secondary device.

In some examples, based at least in part on the monitoring, the techniques may include determining that a network proximity between the primary device and the secondary device exceeds a threshold proximity. For instance, if the proximity-based direct networking connection fails or is otherwise disconnected, then this may be an indication that the networking proximity between the primary device and the secondary device exceeds the threshold proximity. Additionally, or alternatively, if the proximity-based direct networking connection experiences a weak connection or signal, this may be an indication that the networking proximity between the primary device and the secondary device exceeds the threshold proximity. In either of these examples, the proximity between the primary device and the secondary device is used to infer a proximity between the user and the primary device.

In some examples, the techniques may also include causing termination of the access to the resource for the primary device based at least in part on determining that the network proximity exceeds the threshold proximity. That is, the access to the resource for the primary device may be terminated if the secondary device and/or the user is not within the threshold proximity of the primary device. In some examples, the MFA application running on the primary device or the secondary device may cause termination of the access to the resource by sending an indication, to a monitoring service, authentication service, or the like, that the network proximity exceeds the threshold proximity. Additionally, or alternatively, the access to the resource for the primary device may be terminated by the monitoring service based at least in part on the monitoring service detecting that the proximity-based direct networking connection has failed or been disconnected, and/or based on determining that the networking proximity between the devices exceeds the threshold. As such, the monitoring service may then send a logout instruction to the resource(s) (e.g., using a CAEP protocol) or the primary device to terminate the access. In some examples, causing termination of the access for the primary device may include restricting access of a portion of data flows between the primary device and the resource based on policy. For instance, a security policy may specify that when the networking proximity is exceeded the primary device may only have access to certain data flows (e.g., access to only those data flows that are already established).

In additional or alternative examples, based at least in part on the monitoring, the techniques may include determining a period of time in which the network proximity between the primary device and the secondary device has exceeded the threshold proximity. In some examples, causing termination of the access to the resource for the primary device may be further based at least in part on a determination that a length of the period of time meets or exceeds a threshold period of time (e.g., 5 minutes, 10 minutes, etc.).

In some examples, the resource that the primary device is accessing may be a virtual private network (VPN) headend or the like. Additionally, in such an example, causing termination of the access to the resource for the primary device may include restricting access to one or more data flows between the primary device and the VPN headend.

In some examples, various techniques may be used for performing continuous trusted access, whereby already authenticated/active session are terminated/restricted when proximity between a primary device (authenticated device) and a secondary device (authenticating device) changes. For example, in addition, or in the alternative, to monitoring/determining proximity between two devices of an MFA workflow using a proximity-based direct networking connection such as Bluetooth, NFC, Zigbee, etc., other techniques for monitoring/determining proximity may include using network connection data (e.g., Wi-Fi network proximity, SSID changes, etc.), monitoring GPS signals between two devices, and/or other network interface change signals (e.g., when a device moves from having a Wi-fi-based connectivity to having cellular connectivity, moves to a new Wi-Fi network, a loss of networking on the device, etc.). In some examples, any of these other techniques may be used alone or combined with each other, as well as combined with a proximity-based direct networking connection, to determine proximity.

Additionally, by using other techniques to determine proximity, more robust policies can be implemented and enforced. For instance, policies can be implemented that require the primary device and secondary device to be in networking (e.g., domain) proximity, physical proximity, a combination or both, or the like. For instance, GPS data can be monitored to determine a physical proximity between a primary device and secondary device, and the device's network connectivity information can be monitored to determine if the devices are in networking proximity. To this end, data associated with any of the technologies described herein can be received and monitored to determine whether a primary device and secondary device are in proximity before or after authenticating a session, and if the devices ever separate or otherwise are no longer in either network proximity and/or physical proximity, a logout event can take place to terminate or otherwise restrict the authenticated session. That is, although a proximity-based direct networking connection can be indicative of both physical proximity and network proximity, other techniques can be used to determine physical and/or network proximity. Additionally, in some examples, the techniques described herein may allow for policies to be defined for acceptable network connections (e.g., Wi-Fi versus cellular or a specific one or a set of acceptable Wi-Fi SSID(s)). For instance, a policy may be defined that the primary device and/or the secondary device maintain a specific network connection (e.g., Wi-Fi, cellular, etc.) and if that network connection is lost or changes (e.g., from Wi-Fi to cellular) then the session may be terminated or restricted.

According to the technologies of this disclosure, several advantages and improvements in computer-related technology can be realized. For example, the techniques described herein provide for stronger binding of the primary device to the secondary device using indications of proximity (based on establishment of a proximity-based direct networking connection) for the initial session authentication, as well as continuous evaluation of both the primary device workflow and the secondary device to determine if proximity changes should result in session termination. This improves the functioning of MFA systems by providing another layer of security and authentication. Additionally, the techniques of this disclosure allow for the termination of existing sessions between a primary device and a resource based on device proximity, which is indicative of whether the user is actually present at the primary device. This allows organizations to ensure even greater security for their resources by ensuring that the true user of the primary device be in proximity of the primary device in order for the primary device to have access to the resource. These and other advantages and improvements will be readily apparent to those having ordinary skill in the art.

In some examples, because the MFA web-service knows about both the authenticating (e.g. Phone) and authenticated (e.g. Laptop) devices, and because the MFA application (e.g., Duo Health Application) runs on the authenticated device, the MFA application can be instructed by the MFA web-service as to when to invoke BlueToothAuthenticateDeviceEx, and which pairing device to talk to, along with any out of band data the MFA web-service wants exchanged between the two devices (e.g. a bearer token, for example). Such a process may be sufficient to establish a trusted pairing between the two devices that is directly part of the MFA workflow. Once the initial pairing is built by the MFA application, it can simply monitor the association for future MFA cycles. Even in the case where the MFA workflow is not what induced the initial device association (e.g., Bluetooth pairing is unaffiliated with the MFA operations), a callback API may still allow the MFA application to participate directly in the pairing ceremony between the devices.

In some examples, there may be many other possible additional techniques that can improve the security of the solution by performing a data exchange over the newly paired channel as well (although this may not be necessary to securely prove/trust the association). For instance, the data channel (e.g., proximity-based network connection) may be used to provide a second level of assurance by using a standards-based protocol like Hybrid Public Key Encryption (HPKE) to exchange some data between the 3 parties in the workflow (primary/authenticated device (e.g., laptop/computer), secondary/authenticator device (e.g., phone), and the MFA web-service).

Certain implementations and embodiments of the disclosure will now be described more fully below with reference to the accompanying figures, in which various aspects are shown. However, the various aspects may be implemented in many different forms and should not be construed as limited to the implementations set forth herein. The disclosure encompasses variations of the embodiments, as described herein. Like numbers refer to like elements throughout.

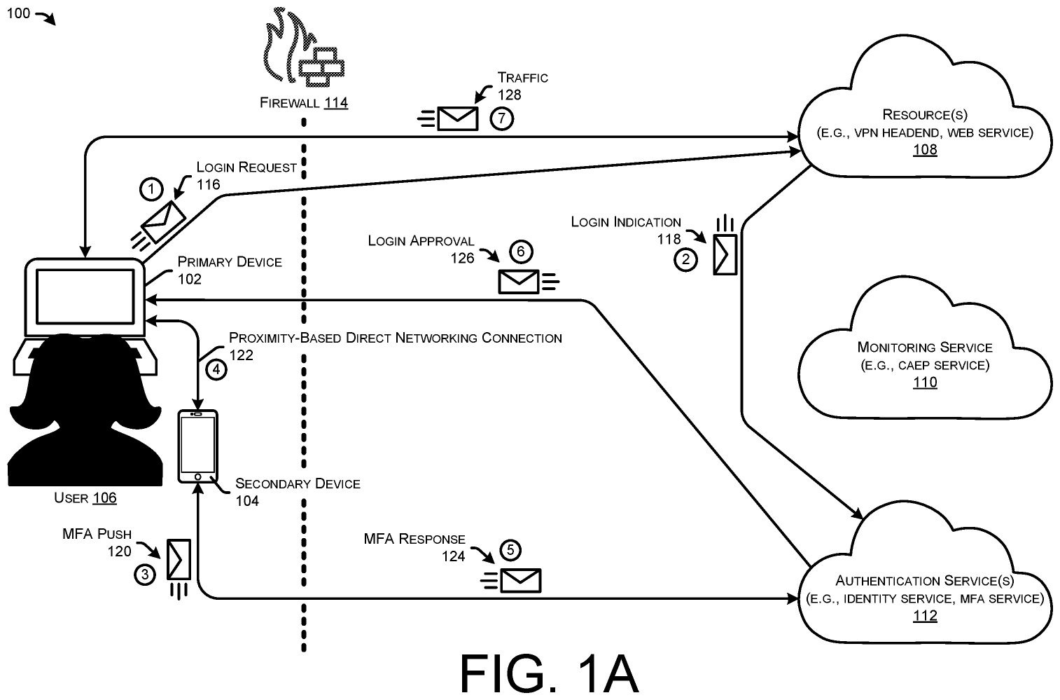

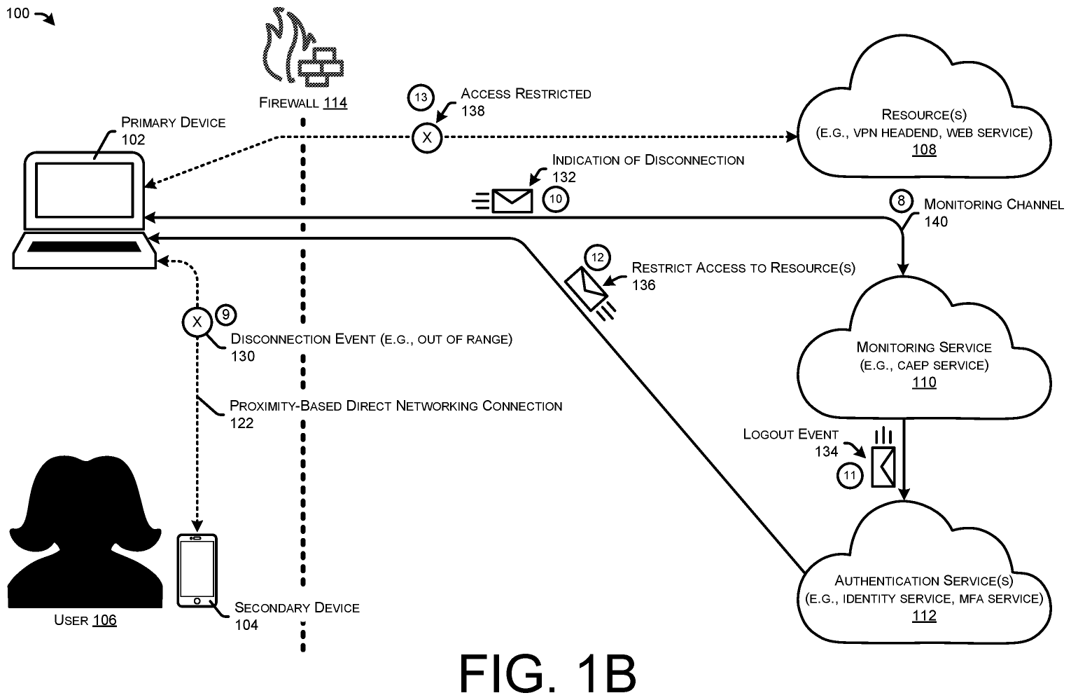

FIGS. 1A and 1B collectively illustrate an example architecture 100 that may implement various aspects of the technologies described herein. In FIGS. 1A and 1B, various example steps “1-13” associated with the technologies described herein are shown. These steps illustrate an example data flow/process associated with using device proximity of a primary device and a secondary device to allow or deny connections to resource(s), as well as to terminate existing connections to the resource(s).

The architecture 100 includes a primary device 102 and a secondary device 104, which may be associated with a user 106. In the illustrative example, the primary device 102 represents a laptop and the secondary device 104 represents a cell phone. However, as noted above and herein, the primary device 102 and the secondary device 104 may be any type of electronic device capable of communicating data over a network.

The architecture 100 also includes one or more resource(s) 108. In some examples, the resource(s) 108 may include applications, services, virtual machines, computing resources, and the like. For instance, the resource(s) 108 may include a web service, a virtual private network (VPN) headend service, a container-based application running on an application orchestration system (e.g., Kubernetes), or the like. In some examples, the resource(s) 108 may be cloud-native resources, on-prem resources, and/or the like.

The architecture 100 also includes a monitoring service 110 and one or more authentication service(s) 112. The monitoring service 110 may, in some examples, be a Continuous Access Evaluation Protocol (CAEP) service. In some examples, the one or more authentication service(s) 112 may include identity services (e.g., Azure Active Directory, etc.), multifactor authentication (MFA) services (e.g., Duo, Microsoft Authenticator, etc.), or the like. In some examples, the primary device 102 and/or the secondary device 104 may send traffic to the resource(s) 108, the monitoring service 110, and/or the authentication service(s) 112 through a firewall 114.

At “1,” the primary device 102 may send a login request 116 to the resource(s) 108 in association with requesting access to one or more of the resource(s) 108. At “2,” the resource(s) 108 may send a login indication 118 to the authentication service(s) 112 to invoke one or more of the authentication service(s) 112 to authenticate the primary device 102 and/or the user 106. For instance, the login indication 118 may be sent to an identity provider service (e.g., active directory, etc.) for authenticating the user 106 of the primary device 102.

At “3,” the authentication service(s) 112 may send a multifactor authentication (MFA) push notification 120 to a secondary device 104 associated with the user 106. For instance, an MFA service of the one or more authentication service(s) 112 may be invoked to initiate a multifactor authentication workflow to authenticate the user 106. At “4,” the secondary device 104 may establish a proximity-based direct networking connection 122 (e.g., NFC connection, Bluetooth connection, Wi-Fi connection, etc.) with the primary device 102. In some examples, the secondary device 104, or an MFA application running on the secondary device 104, may determine to establish the proximity-based direct networking connection 122 between the primary device 102 and the secondary device 104 based at least in part on receiving the MFA push notification 120. That is, in some instances, the proximity-based direct networking connection 122 may be established at least partially responsive to the MFA push notification 120 being received at the secondary device 104. Additionally, or alternatively, in some instances the proximity-based direct networking connection 122 may already be established and/or active between the primary device 102 and the secondary device 104, and responsive to receiving the MFA push notification 120, the secondary device 104, or the MFA application running on the secondary device 104, may determine that the proximity-based direct networking connection 122 is established/active.

At “5,” the secondary device 104 may send an MFA response indication 124 to the authentication service(s) 112. In some examples, the MFA response indication 124 may indicate, among other things, that an active proximity-based direct networking connection 122 exists between the primary device 102 and the secondary device 104. For instance, in addition to the user 106 physically responding to the MFA push notification 120, the proximity-based direct networking connection 122 between the primary device 102 and the secondary device 104 may be a factor of the MFA workflow to authenticate the user 106. At “6,” after receiving a positive MFA response notification 124, the authentication service(s) 112 may send a login approval indication 126 to the primary device 102 (or the resource(s) 108, although not explicitly illustrated in FIG. 1A). At “7,” after the login has been approved, the primary device 102 and the resource(s) 108 may begin a session for sending traffic 128 back and forth through the firewall 114.

In some examples, while the session is active for the primary device 102 to access or otherwise send and receive traffic to and from the resource(s) 108, it may be required (e.g., by a security policy associated with either one of the resource or an organization of the user) that the proximity-based direct networking connection 122 remain established/active. As such, at “8,” a monitoring channel 140 may be used by the monitoring service 110 to monitor the status of the proximity-based direct networking connection 122 between the primary device 102 and the secondary device 104. In some examples, the proximity-based direct networking connection 122 may be continuously monitored by the MFA application running on the secondary device 104, by another MFA application running on the primary device 102, by the monitoring service 110, and/or the like. For instance, the MFA application running on the secondary device 104 may monitor the health of the proximity-based direct networking connection 122 (e.g., whether the connection is active, whether the connection is stable, the strength of the connection, etc.) by receiving and/or analyzing data associated with the proximity-based direct networking connection 122. Additionally, or alternatively, the monitoring service 110 may monitor the proximity-based direct networking connection 122 by, for instance, receiving telemetry data associated with the proximity-based direct networking connection 122 from the primary device 102 and/or the secondary device 104.

At “9,” a disconnection event 130 occurs with respect to the proximity-based direct networking connection 122. For instance, the user 106 may have left a room, premises, etc. where the primary device 102 was located, and, in doing so, the user 106 took the secondary device 104 with them. As such, when the secondary device 104 moved out of range of the primary device 102, the proximity-based direct networking connection 122 was lost. In other words, because proximity-based direct networking connections, such as NFC, Bluetooth, and the like, only work when two connected devices are within a threshold proximity of each other (e.g., 50 feet, 100 feet, 200 feet, etc.), when the secondary device 104 was moved out of range of the primary device 102, the proximity-based direct networking connection 122 failed.

At “10,” based at least in part on the disconnection event 130, the monitoring service 110 may receive an indication of disconnection 132 indicating that the proximity-based direct networking connection 122 between the primary device 102 and the secondary device 104 failed or otherwise lost connection. Although it is illustrated in FIG. 1B that the monitoring service 110 receives the indication of disconnection 132 from the primary device 102 via the monitoring channel 140, it is to be appreciated that the monitoring service 110 may, additionally or alternatively, receive the indication of disconnection 132 from the secondary device 104, from the MFA application running on either one of the primary device 102 or the secondary device 104, via telemetry data associated with the proximity-based direct networking connection 122, and/or in other ways. In examples, the indication of disconnection 132 is at least one way of indicating that the network proximity between the primary device 102 and the secondary device 104 exceeds the threshold proximity. As discussed above and herein, other ways may be used to determine that the network proximity between the primary device 102 and the secondary device 104 exceeds the threshold proximity, such as detecting a weak connection, a latency associated with the connection, or the like.

At “11,” based at least in part on the monitoring service 110 determining that the network proximity between the first device 102 and the second device 104 exceeds the threshold proximity, the monitoring service 110 may send a logout event 134 to the authentication service 112 (e.g., using CAEP techniques). At “12,” the authentication service 112 may send an indication 136 to restrict access to the resource(s) 108, and at “13,” access is restricted 138 for the primary device 102 session with the resource(s) 108. In some examples, restricting access to the resource(s) 108 may include causing termination of the session between the primary device 102 and the resource(s) 108. In some examples, restricting access to the resource(s) 108 may additionally, or alternatively, include restricting access of a portion of data flows between the primary device 102 and the resource(s) 108 based on policy. For instance, a security policy may specify that when the networking proximity is exceeded between the primary device 102 and the secondary device 104, the primary device 102 may only have access to certain data flows (e.g., access to only those data flows that are already established, access to only those data flows that are approved, and the like).

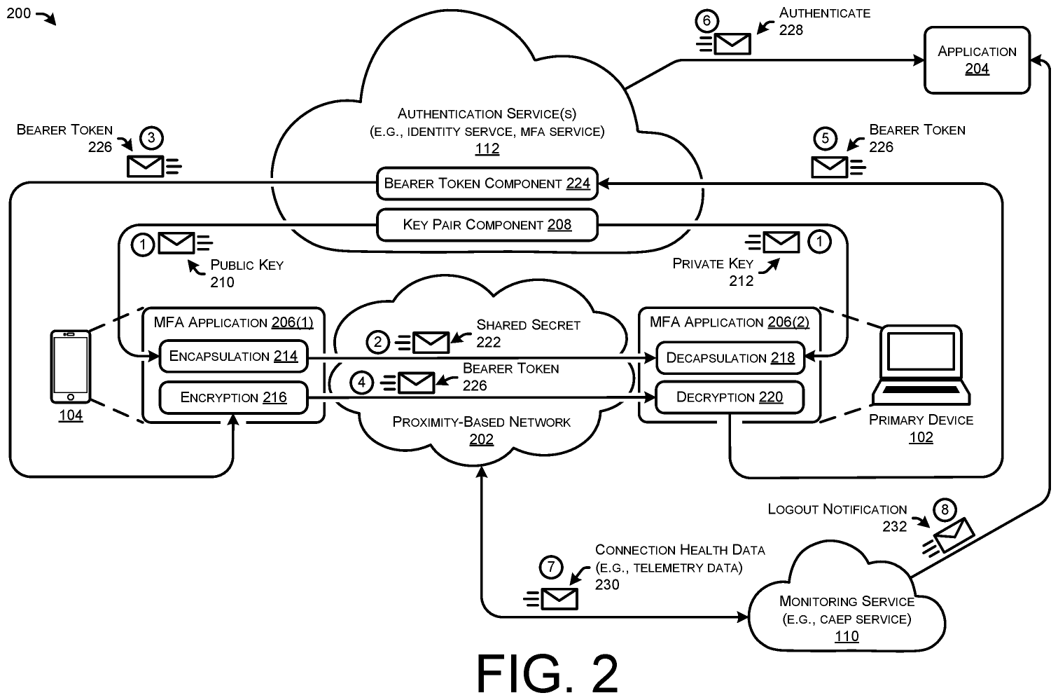

FIG. 2 illustrates an example implementation 200 of the techniques described herein in which a data channel over a proximity-based network 202 is used to provide a second level of assurance in a multifactor authentication workflow. In the implementation 200, the data channel—which may be a proximity-based direct networking connection 122—between the primary device 102 and the secondary device 104 is used to provide a second level of assurance by using a standards-based protocol (e.g., Hybrid Public Key Encryption (HPKE)) to exchange data between the 3 parties of the multifactor authentication workflow (those being the primary device 102, the secondary device 104, and the authentication service(s) 112).

In some examples, the example steps “1-8” shown in FIG. 2 may be performed in association with authenticating a user of the primary device 102 to access an application 204, as well as to terminate or otherwise restrict access to the application 204 for the primary device 102 for a pre-existing session. At “1,” the authentication service(s) 112 may send a key pair to MFA applications 206(1) and 206(2) running on the secondary device 104 and the primary device 102, respectively. For instance, a key pair component 208 of the authentication service(s) 112 may send a public key 210 to the secondary device 104 and may also send a private key 212 to the primary device 102.

At “2,” the MFA application 206(1) of the secondary device 104 may utilize an encapsulation component 214 to encapsulate the public key 210 and send, over the proximity-based network 202, an encapsulated shared secret 222 containing the public key 210 to the MFA application 206(2) of the primary device 102. The MFA application 206(2) of the primary device 102 may utilize a decapsulation component 218 to decapsulate the shared secret 222 and determine whether there is an association between the public key 210 and the private key 212. In this way, a decryption component 220 of the MFA application 206(2) of the primary device 102 may use the private key 212 to decrypt any encrypted messages received from the MFA application 206(1) of the secondary device 104. Further, in some examples, an encryption component 216 the MFA application 206(1) of the secondary device 104 may utilize the public key 210 to send encrypted messages to the primary device 102.

At “3,” a bearer token component 224 of the authentication service(s) 112 may generate and send a bearer token 226 to the secondary device 104. Utilizing the public key 210, the encapsulation component 214 and/or the encryption component 216 may encapsulate and/or encrypt the bearer token 226 and, at “4”, send the encapsulated/encrypted bearer token 226 over the proximity-based network 202 to the primary device 102. At least partially responsive to receiving the bearer token 226, the MFA application 206(2) of the primary device 102 may, using the private key 212, decapsulate and/or decrypt the encrypted bearer token 226. That is, the decapsulation component 218 and/or the decryption component 220 may decapsulate and/or decrypt the bearer token 226. Then, at “5,” the primary device 102 may send the bearer token 226 back to the authentication service(s) 112 for verification by the bearer token component 224.

After the channel over the proximity-based network 202 is established between the primary device 102 and the secondary device 104, and after that channel has also been verified as being secure, the authentication service(s) 112 may, at “6,” send an indication to authenticate 228 the primary device 102 to access the application 204. While the session is established and active such that the primary device 102 can access the application 204, at “7,” the monitoring service 110 may receive connection health data 230 associated with the channel over the proximity-based network 202. In some examples, the connection health data 230 may indicate whether the channel (e.g., proximity-based direct networking connection) is active, a latency associated with the channel, and/or other data which may be indicative of the proximity between the primary device 102 and the secondary device 104.

If the monitoring service 110 detects a failure of the channel between the primary device 102 and the secondary device 104, or detects that the networking proximity is greater than a threshold proximity, the monitoring service 110 may, at “8,” send a logout notification 232 to the application 204, causing restriction of access for the primary device 102 to the application 204.

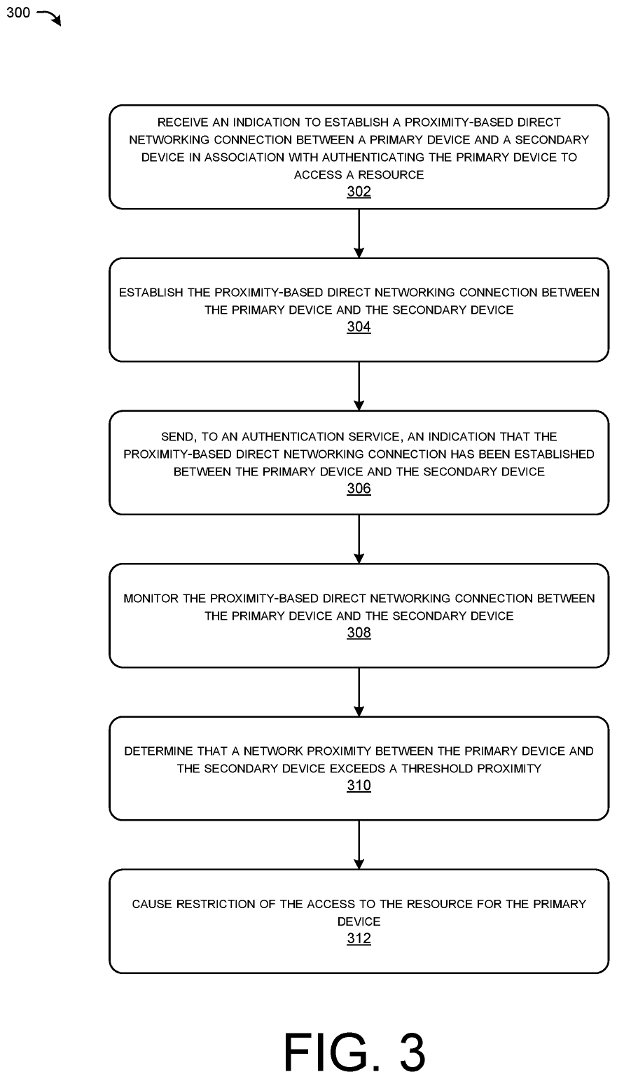

FIG. 3 is a flow diagram illustrating an example method 300 associated with the techniques described herein for proximity-aware multifactor authentication for continuous trusted access. The logical operations described herein with respect to FIG. 3 may be implemented (1) as a sequence of computer-implemented acts or program modules running on a computing system and/or (2) as interconnected machine logic circuits or circuit modules within the computing system.

The implementation of the various components described herein is a matter of choice dependent on the performance and other requirements of the computing system. Accordingly, the logical operations described herein are referred to variously as operations, structural devices, acts, or modules. These operations, structural devices, acts, and modules can be implemented in software, in firmware, in special purpose digital logic, and any combination thereof. It should also be appreciated that more or fewer operations might be performed than shown in FIG. 3 and described herein. These operations can also be performed in parallel, or in a different order than those described herein. Some or all of these operations can also be performed by components other than those specifically identified. Although the techniques described in this disclosure is with reference to specific components, in other examples, the techniques may be implemented by less components, more components, different components, or any configuration of components.

The method 300 begins at operation 302, which includes receiving an indication to establish a proximity-based direct networking connection between a primary device and a secondary device in association with authenticating the primary device to access a resource. For instance, an MFA application running on the secondary device 104 may receive the indication to establish the proximity-based direct networking connection 122 between the primary device 102 and the secondary device 104 to authenticate the primary device 102 to access one or more of the resource(s) 108. In some examples, the indication may be an MFA push notification, and the MFA application running on the secondary device may determine to establish the proximity-based direct networking connection between the primary device and the secondary device in response to receiving the MFA push notification. For instance, the secondary device may receive the MFA push notification in response to the user of the primary device attempting to authenticate to access a secured resource using the primary device, and the MFA push notification may indicate that the proximity-based direct networking connection needs to be established as a factor for an MFA workflow associated with authenticating the primary device.

At operation 304, the method 300 includes establishing the proximity-based direct networking connection between the primary deice and the secondary device. For instance, the MFA application running on the secondary device 104 may cause the proximity-based direct networking connection 122 to be established between the primary device 102 and the secondary device 104. For instance, the MFA application may cause the secondary device to establish a Bluetooth, NFC, Wi-Fi, or other proximity-based networking connection (including both direct connections and indirect connections through a router) with the primary device. In some examples, if an active proximity-based direct networking connection already exists between the primary device and the secondary device, the MFA application may determine that such a connection already is active and refrain from causing a new proximity-based direct networking connection to be established. In some example, other techniques may be used besides proximity-based direct networking connections to show proximity. For instance, if the secondary device is plugged into the primary device, the MFA application may determine that this condition suffices as an exception to establishing a new proximity-based direct networking connection.

At operation 306, the method 300 includes sending, to an authentication service, an indication that the proximity-based direct networking connection has been established between the primary device and the secondary device. For instance, upon establishing the proximity-based direct networking connection 122—or determining that an existing connection is active or that a sufficient, alternative connection exists—the indication may be sent to the authentication service 112 (e.g., MFA service) to indicate that the proximity-based direct networking connection 122 has been established. In some examples, an active proximity-based direct networking connection between the primary device and the secondary device may be a factor of the MFA workflow, and upon the authentication service receiving the indication of the active proximity-based direct networking connection, the authentication service may grant the primary device with access to the resource. That is, the authentication service may authenticate the primary device to establish a communication session with the resource, or to otherwise access the resource.

At operation 308, the method 300 includes monitoring the proximity-based direct networking connection between the primary device and the secondary device. For instance, the MFA application running on the secondary device 104, an MFA application running on the primary device 102, the monitoring service 110, or the like may monitor the proximity-based direct networking connection between the primary device 102 and the secondary device 104. For instance, the MFA application running on the secondary device may monitor the health of the proximity-based direct networking connection (e.g., whether the connection is active, whether the connection is stable, the strength of the connection, etc.) by receiving and/or analyzing data associated with the proximity-based direct networking connection.

Additionally, or alternatively, the monitoring service may monitor the proximity-based direct networking connection by, for instance, receiving telemetry data associated with the proximity-based direct networking connection from the primary device and/or the secondary device.

At operation 310, the method 300 includes determining that a network proximity between the primary device and the secondary device exceeds a threshold proximity. For instance, the MFA application running on the secondary device 104, an MFA application running on the primary device 102, the monitoring service 110, or the like may determine that the network proximity between the primary device 102 and the secondary device 104 exceeds the threshold proximity. For instance, if the proximity-based direct networking connection fails or is otherwise disconnected, then this may be an indication that the networking proximity between the primary device 102 and the secondary device 104 exceeds the threshold proximity. Additionally, or alternatively, if the proximity-based direct networking connection experiences a weak connection or signal, this may be an indication that the networking proximity between the primary device and the secondary device exceeds the threshold proximity. In either of these examples, the proximity between the primary device and the secondary device is used to infer a proximity between the user and the primary device.

At operation 312, the method 300 includes causing restriction of the access to the resource for the primary device. For instance, the MFA application running on the secondary device 104, an MFA application running on the primary device 102, the monitoring service 110, or the like may cause the restriction of the access to the resource(s) 108 for the primary device 102 based at least in part on determining that the network proximity exceeds the threshold proximity. That is, the access to the resource for the primary device may be restricted, terminated, or the like if the secondary device and/or the user is not within the threshold proximity of the primary device. In some examples, the MFA application running on the primary device or the secondary device may cause termination of the access to the resource by sending, to the monitoring service, authentication service, or the like, an indication that the network proximity exceeds the threshold proximity. Additionally, or alternatively, the access to the resource for the primary device may be caused to be restricted by the monitoring service based at least in part on the monitoring service detecting that the proximity-based direct networking connection has failed or been disconnected, and/or based on determining that the networking proximity between the devices exceeds the threshold. As such, the monitoring service may then send a logout instruction to the resource(s) (e.g., using a CAEP protocol) or the primary device to terminate the access. In some examples, causing restriction of the access for the primary device may include restricting access of a portion of data flows between the primary device and the resource based on policy. For instance, a security policy may specify that when the networking proximity is exceeded the primary device may only have access to certain data flows (e.g., access to only those data flows that are already established).

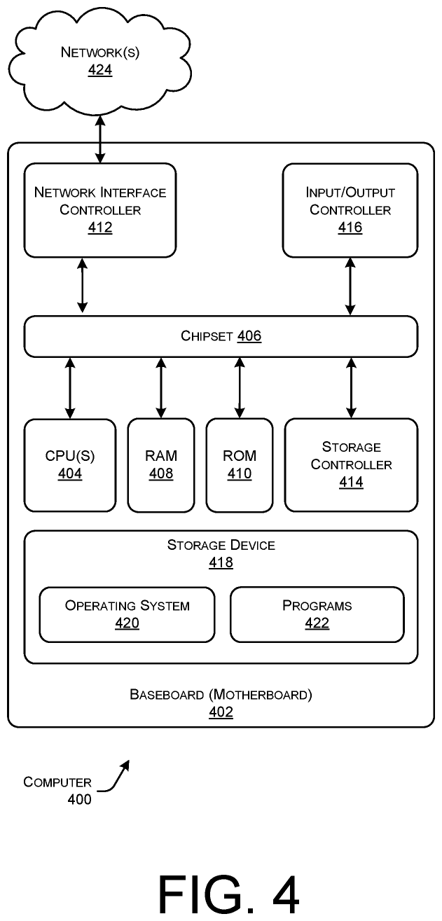

FIG. 4 is a computer architecture diagram showing an illustrative computer hardware architecture for implementing a computing device that can be utilized to implement aspects of the various technologies presented herein. The computer architecture shown in FIG. 4 illustrates a conventional server computer, network node (e.g., secure access node), router, workstation, desktop computer, laptop, tablet, network appliance, e-reader, smartphone, load balancer, or other computing device, and can be utilized to execute any of the software components presented herein.

The computer 400 includes a baseboard 402, or “motherboard,” which is a printed circuit board to which a multitude of components or devices can be connected by way of a system bus or other electrical communication paths. In one illustrative configuration, one or more central processing units (“CPUs”) 404 operate in conjunction with a chipset 406. The CPUs 404 can be standard programmable processors that perform arithmetic and logical operations necessary for the operation of the computer 400.

The CPUs 404 perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

The chipset 406 provides an interface between the CPUs 404 and the remainder of the components and devices on the baseboard 402. The chipset 406 can provide an interface to a RAM 408, used as the main memory in the computer 400. The chipset 406 can further provide an interface to a computer-readable storage medium such as a read-only memory (“ROM”) 410 or non-volatile RAM (“NVRAM”) for storing basic routines that help to startup the computer 400 and to transfer information between the various components and devices. The ROM 410 or NVRAM can also store other software components necessary for the operation of the computer 400 in accordance with the configurations described herein.

The computer 400 can operate in a networked environment using logical connections to remote computing devices and computer systems through a network. The chipset 406 can include functionality for providing network connectivity through a NIC 412, such as a gigabit Ethernet adapter. The NIC 412 is capable of connecting the computer 400 to other computing devices over the network 424. It should be appreciated that multiple NICs 412 can be present in the computer 400, connecting the computer to other types of networks and remote computer systems. In some examples, the NIC 412 may be configured to perform at least some of the techniques described herein.

The computer 400 can be connected to a storage device 418 that provides non-volatile storage for the computer. The storage device 418 can store an operating system 420, programs 422, and data, which have been described in greater detail herein. The storage device 418 can be connected to the computer 400 through a storage controller 414 connected to the chipset 406. The storage device 418 can consist of one or more physical storage units. The storage controller 414 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The computer 400 can store data on the storage device 418 by transforming the physical state of the physical storage units to reflect the information being stored. The specific transformation of physical state can depend on various factors, in different embodiments of this description. Examples of such factors can include, but are not limited to, the technology used to implement the physical storage units, whether the storage device 418 is characterized as primary or secondary storage, and the like.

For example, the computer 400 can store information to the storage device 418 by issuing instructions through the storage controller 414 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computer 400 can further read information from the storage device 418 by detecting the physical states or characteristics of one or more particular locations within the physical storage units.

In addition to the mass storage device 418 described above, the computer 400 can have access to other computer-readable storage media to store and retrieve information, such as program modules, data structures, or other data. It should be appreciated by those skilled in the art that computer-readable storage media is any available media that provides for the non-transitory storage of data and that can be accessed by the computer 400. In some examples, the operations performed by the architecture 100 and or any components included therein, may be supported by one or more devices similar to computer 400. Stated otherwise, some or all of the operations performed by the architecture 100, and or any components included therein, may be performed by one or more computer devices 400 operating in a scalable arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage device 418 can store an operating system 420 utilized to control the operation of the computer 400. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage device 418 can store other system or application programs and data utilized by the computer 400.

In one embodiment, the storage device 418 or other computer-readable storage media is encoded with computer-executable instructions which, when loaded into the computer 400, transform the computer from a general-purpose computing system into a special-purpose computer capable of implementing the embodiments described herein. These computer-executable instructions transform the computer 400 by specifying how the CPUs 404 transition between states, as described above. According to one embodiment, the computer 400 has access to computer-readable storage media storing computer-executable instructions which, when executed by the computer 400, perform the various processes and functionality described above with regard to FIGS. 1A-3, and herein. The computer 400 can also include computer-readable storage media having instructions stored thereupon for performing any of the other computer-implemented operations described herein.

The computer 400 can also include one or more input/output controllers 416 for receiving and processing input from a number of input devices, such as a keyboard, a mouse, a touchpad, a touch screen, an electronic stylus, or other type of input device. Similarly, an input/output controller 416 can provide output to a display, such as a computer monitor, a flat-panel display, a digital projector, a printer, or other type of output device. It will be appreciated that the computer 400 might not include all of the components shown in FIG. 4, can include other components that are not explicitly shown in FIG. 4, or might utilize an architecture completely different than that shown in FIG. 4.

The computer 400 may include one or more hardware processors (processors) configured to execute one or more stored instructions. The processor(s) may comprise one or more cores. Further, the computer 400 may include one or more network interfaces configured to provide communications between the computer 400 and other devices. The network interfaces may include devices configured to couple to personal area networks (PANs), wired and wireless local area networks (LANs), wired and wireless wide area networks (WANs), and so forth. For example, the network interfaces may include devices compatible with Ethernet, Wi-Fi™, and so forth.

The programs 422 may comprise any type of programs or processes to perform the techniques described in this disclosure for using device proximity of a primary device and a secondary device to allow or deny connections to secured resource(s), as well as terminate existing connections to the secured resource(s).

While the invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims of the application.

What is claimed is:

1. A method comprising: monitoring a proximity-based direct networking connection between a primary device and a secondary device, the proximity-based direct networking connection established in association with authenticating the primary device to access a resource;
determining, based at least in part on the monitoring, that a proximity between the primary device and the secondary device exceeds a threshold proximity; and
based at least in part on determining that the proximity exceeds the threshold proximity, causing termination of the access to the resource for the primary device.

2. The method of claim 1, further comprising detecting a disconnection in the proximity-based direct networking connection between the primary device and the secondary device, wherein determining that the proximity between the primary device and the secondary device exceeds the threshold proximity is based at least in part on detecting the disconnection.

3. The method of claim 1, wherein causing termination of the access to the resource for the primary device comprises causing termination of the access to a portion of the resource for the primary device based at least in part on a security policy associated with at least one of the resource or the primary device.

4. The method of claim 1, wherein a communication protocol associated with the proximity-based direct networking connection is at least one of a Bluetooth protocol or a near-field communication (NFC) protocol.

5. The method of claim 1, further comprising:
determining that the proximity-based direct networking connection has been established between the primary device and the secondary device; and
responsive to determining that the proximity-based direct networking connection has been established between the primary device and the secondary device, causing the primary device to be authenticated to access the resource.

6. The method of claim 1, further comprising:
determining, based at least in part on the monitoring, a period of time in which the proximity between the primary device and the secondary device has exceeded the threshold proximity; and
determining that the period of time meets or exceeds a threshold period of time;
wherein causing the termination of the access to the resource for the primary device is further based at least in part on the period of time meeting or exceeding the threshold period of time.

7. The method of claim 1, wherein the resource is a virtual private network (VPN) headend and causing termination of the access to the resource for the primary device comprises restricting access to one or more data flows between the primary device and the VPN headend.

8. The method of claim 1, wherein the proximity is at least one of a physical proximity or a network proximity, the method further comprising:
monitoring additional data associated with the primary device and the secondary device, the additional data indicative of either the physical proximity or the networking proximity, the data including at least one of:
global positioning system (GPS) data associated with each of the primary device and the secondary device, the GPS data indicative of the physical proximity between the primary device and the secondary device;
network connection data associated with each of the primary device and the secondary device, the network connection data indicative of at least one of the physical proximity or the networking proximity between the primary device and the secondary device; or
network interface data associated with each of the primary device and the secondary device, the network interface data indicative of at least one of the physical proximity or the networking proximity between the primary device and the secondary device.

9. A system comprising: one or more processors; and
one or more non-transitory computer-readable media storing instructions that, when executed, cause the one or more processors to perform operations comprising:
monitoring a proximity-based direct networking connection between a primary device and a secondary device, the proximity-based direct networking connection established in association with authenticating the primary device to access a resource;
determining, based at least in part on the monitoring, that a proximity between the primary device and the secondary device exceeds a threshold proximity; and
based at least in part on determining that the proximity exceeds the threshold proximity, causing termination of the access to the resource for the primary device.

10. The system of claim 9, the operations further comprising detecting a disconnection in the proximity-based direct networking connection between the primary device and the secondary device, wherein determining that the proximity between the primary device and the secondary device exceeds the threshold proximity is based at least in part on detecting the disconnection.

11. The system of claim 9, wherein causing termination of the access to the resource for the primary device comprises causing termination of the access to a portion of the resource for the primary device based at least in part on a security policy associated with at least one of the resource or the primary device.

12. The system of claim 9, wherein a communication protocol associated with the proximity-based direct networking connection is at least one of a Bluetooth protocol or a near-field communication (NFC) protocol.

13. The system of claim 9, the operations further comprising:
determining that the proximity-based direct networking connection has been established between the primary device and the secondary device; and
responsive to determining that the proximity-based direct networking connection has been established between the primary device and the secondary device, causing the primary device to be authenticated to access the resource.

14. The system of claim 9, the operations further comprising:
determining, based at least in part on the monitoring, a period of time in which the proximity between the primary device and the secondary device has exceeded the threshold proximity; and
determining that the period of time meets or exceeds a threshold period of time;
wherein causing the termination of the access to the resource for the primary device is further based at least in part on the period of time meeting or exceeding the threshold period of time.

15. The system of claim 9, wherein the resource is a virtual private network (VPN) headend and causing termination of the access to the resource for the primary device comprises restricting access to one or more data flows between the primary device and the VPN headend.

16. One or more non-transitory computer-readable media storing instructions that, when executed, cause one or more processors to perform operations comprising:
monitoring a proximity-based direct networking connection between a primary device and a secondary device, the proximity-based direct networking connection established in association with authenticating the primary device to access a resource;
determining, based at least in part on the monitoring, that a proximity between the primary device and the secondary device exceeds a threshold proximity; and
based at least in part on determining that the proximity exceeds the threshold proximity, causing termination of the access to the resource for the primary device.

17. The one or more non-transitory computer-readable media of claim 16, the operations further comprising detecting a disconnection in the proximity-based direct networking connection between the primary device and the secondary device, wherein determining that the proximity between the primary device and the secondary device exceeds the threshold proximity is based at least in part on detecting the disconnection.

18. The one or more non-transitory computer-readable media of claim 16, wherein causing termination of the access to the resource for the primary device comprises causing termination of the access to a portion of the resource for the primary device based at least in part on a security policy associated with at least one of the resource or the primary device.

19. The one or more non-transitory computer-readable media of claim 16, wherein a communication protocol associated with the proximity-based direct networking connection is at least one of a Bluetooth protocol or a near-field communication (NFC) protocol.

20. The one or more non-transitory computer-readable media of claim 16, the operations further comprising:
determining that the proximity-based direct networking connection has been established between the primary device and the secondary device; and
responsive to determining that the proximity-based direct networking connection has been established between the primary device and the secondary device, causing the primary device to be authenticated to access the resource.
